(19) United States
(12) Patent Application Publication
(10) Pub. No.: US 2007/0285754 A1
(43) Pub. Date: Dec. 13, 2007

(54) SCANNING APPARATUSES AND RELATED METHODS CAPABLE OF LOCATING OBJECT TO BE SCANNED

(76) Inventors: Ta-Yi Lee, Taipei County (TW); Jeicy Lee, Guangzhou (CN); Jun-Yuan Tang, Xiangtan City (CN); Zero Song, Guangzhou (CN); Zhang-Ming Peng, Mianyang City (CN)

Correspondence Address: NORTH AMERICA INTELLECTUAL PROPERTY CORPORATION, P.O. BOX 506, MERRIFIELD, VA, 22116, US

(21) Appl. No.: 11/627,979

(22) Filed: Jan. 28, 2007

(30) Foreign Application Priority Data
Jun. 7, 2006 (CN) 200610087788.X

(51) Int. Cl. G02B 26/08

(52) U.S. Cl. 359/197

(57) ABSTRACT

Scanning apparatuses and related methods capable of locating object to be scanned are disclosed. One of the proposed scanning apparatuses includes: a tray for supporting objects to be scanned, wherein the tray is provided with a machine detectable mechanism; a detecting module for detecting a pattern of the machine detectable mechanism; a control circuit coupled to the detecting module for identifying at least target area on the tray according to the detecting result of the detecting module and for setting scan parameters according to a location of the at least one target area; and a scanning module coupled to the control circuit for scanning the at least one target area according to the scan parameters.

### BACKGROUND OF THE INVENTION

1. Field of the Invention

The present disclosure relates to image scanning apparatuses, and more particularly, to scanning apparatuses and related methods capable of locating objects to be scanned.

2. Description of the Prior Art

A conventional image scanning apparatus is one of the peripheral devices for a computer system. When a user utilizes the scanning apparatus to scan an object, the user needs to manually set or select corresponding scanning parameters of the scanning apparatus through an application program executed on the computer system. This is because the scanning apparatus cannot automatically identify the type of object to be scanned. For example, the object to be scanned can be generally divided into two categories: transparency (e.g., positive or negative films) and reflection copy (e.g., photos or documents). Therefore, the user has to set the scanning type of the object to be scanned through the application program so that the scanning apparatus can operate correctly.

In order to meet market demands, stand-alone scanning apparatuses that can operate without cooperating with a computer system are being developed. However, such stand-alone scanning apparatuses still cannot automatically identify the type of the object to be scanned. Thus, the user still needs to manually manipulate a control panel on the scanning apparatus in order to set or select corresponding scanning parameters for the object to be scanned.

Furthermore, for both the conventional scanning apparatus that operates in cooperation with the computer system and the newly developed stand-alone scanning apparatus, if the user wants to scan only a portion of the object to be scanned (e.g., part films of a section of negative films), the user must set a target scanning area for the scanning apparatus by manually adjusting the options of the application program or by manually manipulating the control panel. The scanning apparatus can then be controlled to scan only the target scanning area required by the user.

As described in the foregoing illustrations, the conventional scanning apparatus requires the user to manually set many scanning parameters so that it can operate correctly. Obviously, such an operating scheme is very inconvenient for the user.

### SUMMARY OF THE INVENTION

It is therefore an objective of the present disclosure to provide scanning apparatuses and related methods capable of locating objects to be scanned to solve the above-mentioned problems.

An exemplary embodiment of a method for scanning objects on a tray being provided with a machine detectable mechanism is disclosed. The method is for scanning objects on a tray, the tray being provided with a machine detectable mechanism, and the method comprises detecting a pattern of the machine detectable mechanism; identifying at least one target area on the tray according to the detecting result of the machine detectable mechanism; setting scan parameters according to a location of the at least one target area; and scanning the at least one target area according to the scan parameters.

An exemplary embodiment of a scanning apparatus is disclosed comprising a tray for supporting objects to be scanned, wherein the tray is provided with a machine detectable mechanism; a detecting module for detecting a pattern of the machine detectable mechanism; a control circuit coupled to the detecting module for identifying at least one target area on the tray according to the detecting result of the detecting module and for setting scan parameters according to a location of the at least one target area; and a scanning module coupled to the control circuit for scanning the at least one target area according to the scan parameters.

An exemplary embodiment of a scanning apparatus is disclosed comprising a tray for supporting objects to be scanned, wherein the tray is provided with an optically detectable structure; an optical module for detecting a pattern of the optically detectable structure; and a control circuit coupled to the optical module for identifying at least one target area on the tray according to the detecting result of the optical module and for controlling the optical module to only scan the at least one target area.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a simplified functional block diagram of a scanning apparatus according to one embodiment of the present invention.

FIG. 2 is a schematic diagram of a tray of FIG. 1 according to a first embodiment of the present invention.

FIG. 3 is a schematic diagram illustrating a case where the tray of FIG. 2 supports a reflection copy according to one embodiment of the present invention.

FIG. 4 is a schematic diagram of a tray of FIG. 1 according to a second embodiment of the present invention.

FIG. 5 is a schematic diagram illustrating a case where the tray of FIG. 4 supports a negative film according to one embodiment of the present invention.

FIG. 6 is a schematic diagram illustrating a case where the tray of FIG. 4 supports a negative film and a positive film according to one embodiment of the present invention.

FIG. 7 is a flowchart illustrating a scanning method according to one embodiment of the present invention.

### DETAILED DESCRIPTION

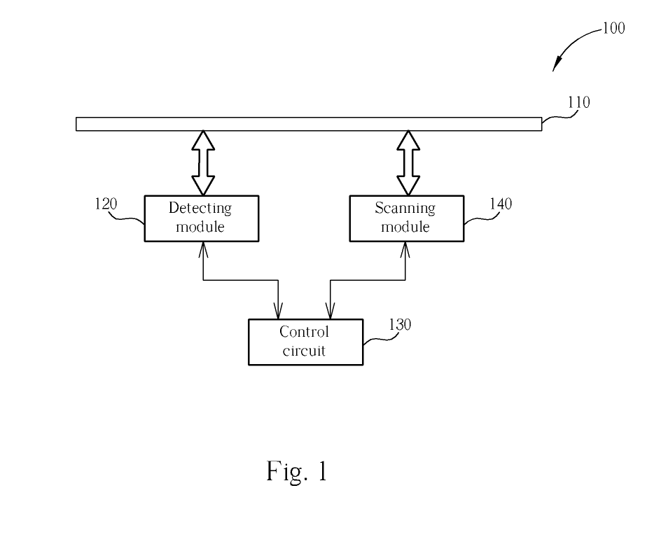

Please refer to FIG. 1, which shows a simplified functional block diagram of a scanning apparatus 100 according to one embodiment of the present invention. As shown in FIG. 1, the scanning apparatus 100 comprises a tray 110 for supporting objects to be scanned; a detecting module 120; a control circuit 130 coupled to the detecting module 120; and a scanning module 140 coupled to the control circuit 130, wherein the scanning module 140 typically comprises lamps, optical sensors (such CCDs), or back light modules. In order to make the scanning apparatus 100 able to automatically identify the object type on the tray 110 (or the type of the tray 110) and/or the location of the objects to be scanned, different types of tray are provided with different patterns of machine detectable mechanism. For example, the pattern of machine detectable mechanism configured on a tray dedicated for supporting reflection copies differs from that of machine detectable mechanism configured on a tray dedicated for supporting transparencies. Accordingly, the scanning apparatus 100 can automatically identify the type of the objects to be scanned (or the type of the tray 110) and/or the location of the objects to be scanned according to the pattern of machine detectable mechanism on the tray 110.

In practice, the machine detectable mechanism can be realized by any devices or structures that can be sensed by machines. For example, the machine detectable mechanism may be one or more optically detectable structures, electrically detectable structures, magnetically detectable structures, or any combination of these detectable structures. Note that the term “optically detectable structure” as used herein encompasses any devices or structures that can be sensed by using optical techniques, such as transparent structures (e.g., openings, glass, or acrylic passing through the tray 110), reflecting parts (e.g., metal films or reflecting mirrors), or light emitting components (e.g., electro luminance or light emitted diode). The term “electrically detectable structure” as used herein encompasses any devices or structures that can be sensed by using electrical/electronic techniques, such as RFID tags. Additionally, the term “magnetically detectable structure” as used herein encompasses any devices or structures that can be sensed by using magnetic techniques, such as magnetic barcodes.

In addition, the detecting module 120 of the scanning apparatus 100 can be implemented in a variety of ways depending upon the implementations of the machine detectable mechanism of the tray 110. For example, if the machine detectable mechanism comprises RFID tags, then the detecting module 120 comprises an RFID reader for reading the RFID tags. If the machine detectable mechanism comprises magnetic barcodes, then the detecting module 120 comprises a barcode reader for reading the magnetic barcodes. Thereto, if the machine detectable mechanism comprises aforementioned optically detectable structures, then the detecting module 120 comprises corresponding photo sensors. Of course, if the machine detectable mechanism is composed of at least two of the optically detectable structure, the electrically detectable structure, and the magnetically detectable structure, then the detecting module 120 requires multiple detecting mechanisms for detecting those structures.

Moreover, since the aforementioned machine detectable mechanism can be arranged in any position of the tray 110, such as on the surface of the tray 110, on one or more sides of the tray 110, or inside the body of the tray 110. Accordingly, the spatial relationship between the detecting module 120 and the tray 110 is not restricted to any specified arrangement.

Please note that separate functional blocks of FIG. 1 may be respectively implemented with distinct devices or integrated into a single device. In a preferred embodiment, for example, the machine detectable mechanism of the tray 110 is embodied by some transparent structures, such as aforementioned openings passing through the tray 110. In this case, the detecting module 120 and the scanning module 140 of the scanning apparatus 100 can be realized by a same optical module.

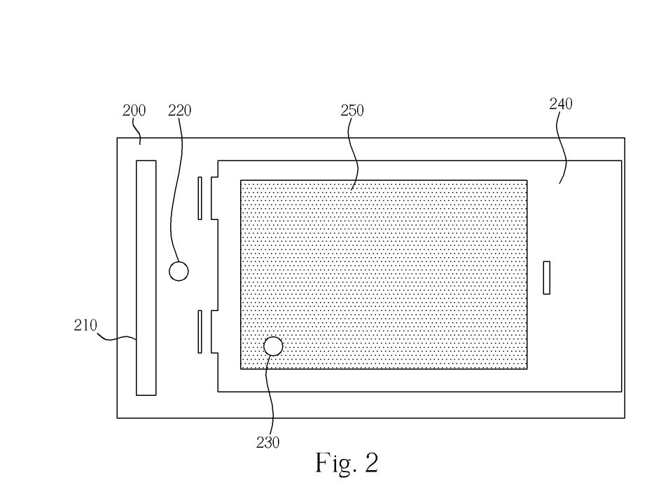

Hereinafter, some embodiments of the machine detectable mechanism of the tray 110 will be introduced with reference to FIG. 2 through FIG. 6. For illustrative purpose, it is herein assumed that the machine detectable mechanism of the tray 110 is implemented with openings categorized in the optically detectable structures. The scanning apparatus 100 identifies the type of object to be scanned on the tray 110 (or the type of the tray 110) and/or the location of the object to be scanned according to the pattern of the openings, such as the number of the openings, the positions of the openings, and/or the shapes of the openings.

In an embodiment shown in FIG. 2, the tray 110 is employed to support objects of transparency type, such as pictures, photos, documents, etc. As shown in FIG. 2, the tray 110 comprises a carrier 200 and a cover 240. The carrier 200 is provided with a test region 210, a machine detectable mechanism 220, and a fool-proof device 230. The test region 210 is designed to be a reference for use in white balance calibration performed by the scanning apparatus 100. The machine detectable mechanism 220 of this case is a single opening positioned on a side of the test region 210 and at a predetermined distance from the test region 210. The machine detectable mechanism 220 is designed for indicating that the tray 110 is a tray for supporting objects of transparency type or that the objects on the tray 110 are belong to transparency type. The fool-proof device 230 is designed such that the scanning apparatus 100 can determine whether the object to be scanned is correctly placed on a proper position of the tray 110 according to the fool-proof device 230. In practice, the fool-proof device 230 may be a light emitting component (e.g., an EL, an LED, etc) embedded in the carrier 200, or a transparent structure passing through the carrier 200, such as an opening, glass, acrylic, etc.

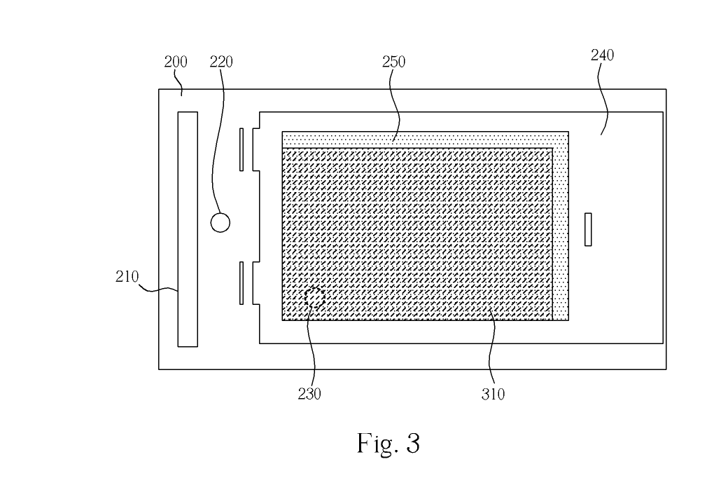

In this embodiment, the cover 240 is provided with a transparent window 250, which can be realized by glass or acrylic, but this is not a restriction of the practical implementations. When the cover 240 is closed onto the carrier 200, the transparency to be scanned would be clipped and sandwiched between the transparent window 250 and the carrier 200. FIG. 3 shows a schematic diagram illustrating a case where a reflection copy 310 is sandwiched between the carrier 200 and the transparent window 250 of the cover 240. As shown in FIG. 3, when the reflection copy 310 is aligned to a corner of the transparent window 250, which is near the fool-proof device 230, light emitted from the fool-proof device 230 or light passing through the fool-proof device 230 will be masked/isolated. Accordingly, the scanning apparatus 100 can determine that the object to be scanned is correctly placed on the tray 110 if no light is sensed at the position of the fool-proof device 230 during pre-scanning. On the contrary, if light is sensed at the position of the fool-proof device 230 by the scanning apparatus 100 during pre-scanning, the scanning apparatus 100 can accordingly determine that there is no object to be scanned being placed on the tray 110 or the object to be scanned is not correctly placed on the tray 110. In this situation, the scanning apparatus 100 can notify the user with an alert message or error message.

Please note that the machine detectable mechanism 220 of the previous embodiment is arranged on the carrier 200 of the tray 110. This is merely an example rather than a restriction of the implementations of the machine detectable mechanism. In practice, the machine detectable mechanism 220 can be arranged only on the cover 240 or on both the carrier 200 and the cover 240. For example, the machine detectable mechanism 220 may be an opening passing through both the carrier 200 and the cover 240.

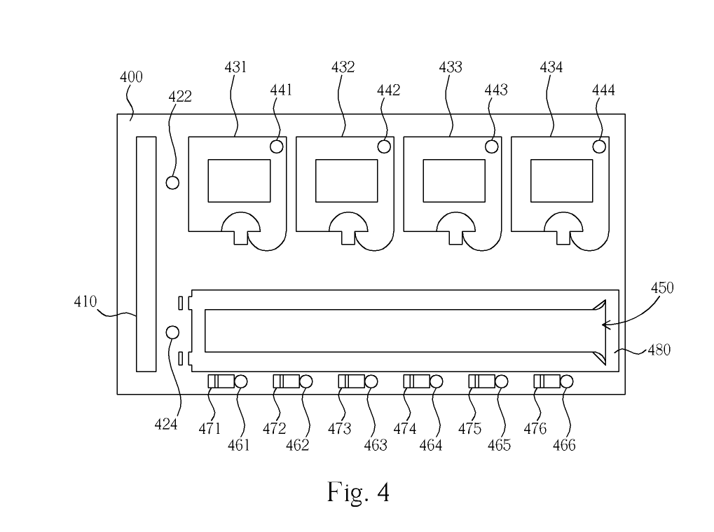

In an embodiment shown in FIG. 4, the tray 110 is a hybrid tray, which is capable of supporting both positive films and negative films at the same time. As shown in FIG. 4, the tray 110 of this embodiment comprises a carrier 400 and a cover 480. The carrier 400 comprises a test region 410 for use as a reference in the white balance calibration of the scanning apparatus 100; a machine detectable mechanism formed by a plurality of openings 422, 424, 441, 442, 443, 444, 461, 462, 463, 464, 465, and 466; four positive film holders 431, 432, 433, and 434; a negative film scanning area 450; and a plurality of light-masking components 471, 472, 473, 474, 475, and 476 respectively corresponding to the openings 461, 462, 463, 464, 465, and 466 beside the cover 480. In this case, the two openings 422 and 424, which are positioned on a side of the test region 410 and at a predetermined distance from the test region 410, are designed for indicating that the tray 110 is a hybrid tray or that the objects on the tray 110 are positive films or negative films.

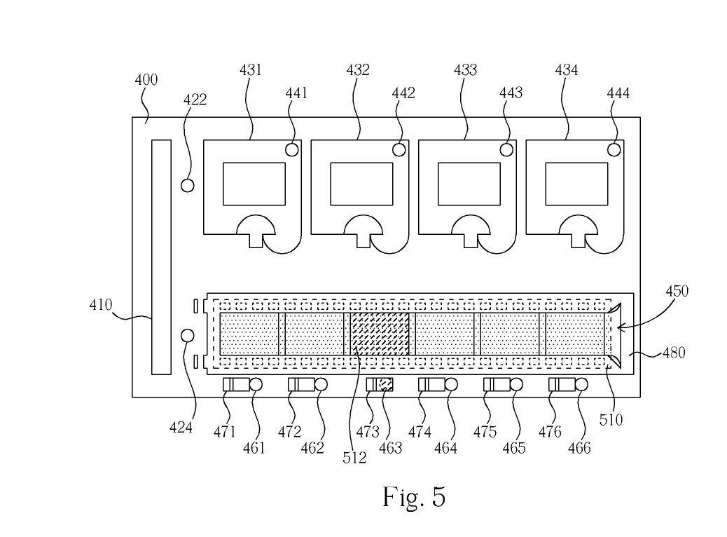

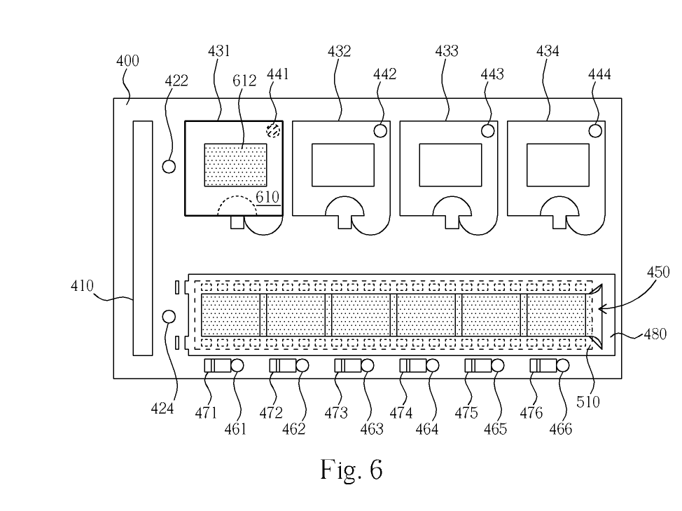

When the cover 480 is closed onto the carrier 400, the negative film to be scanned would be clipped and sandwiched between the cover 480 and the carrier 400. As shown in FIG. 5 and FIG. 6, when a negative film 510 is sandwiched between the carrier 400 and the cover 480, image frames of the negative film 510 are exposed within the negative film scanning area 450.

By comparing the two different trays shown in FIG. 2 and FIG. 4, it is obvious that the machine detectable mechanism arranged beside the test region 210 and the machine detectable mechanism arranged beside the test region 410 have different patterns, such as the number and positions of openings. The scanning apparatus 100 can identify the type of currently used tray 110 based on this difference. For example, the scanning apparatus 100 can utilize a lamp of the optical module to illuminate a side of the tray 110, and utilize a photo sensor of the optical module to sense from another side of the tray 110. When light emitted from the lamp passes through an opening of the tray 110 to the photo sensor, a correspondingly pulse is generated by the photo sensor. Accordingly, the scanning apparatus 100 can determine the number of openings on the tray 110 according to the number of pulses generated by the photo sensor of the optical module to identify the type of the tray 110. In another aspect, the scanning apparatus 100 can determine the type of object to be scanned on the tray 110 according to the pattern of the machine detectable mechanism of the tray 110.

As shown in FIG. 4, in addition to the openings 422 and 424 for identifying the type of object to be scanned, the tray 110 further comprises openings 441, 442, 443, and 444, which are used for locating positive films to be scanned, and openings 461, 462, 463, 464, 465, and 466, which are used for locating negative film frames to be scanned. Hereinafter, the method for locating the objects to be scanned on the tray 110 will be explained with reference to FIG. 5 and FIG. 6.

FIG. 5 shows an embodiment where the negative film 510 is placed in the negative film scanning area 450 of the tray 110, but no positive film is placed on the four positive film holders 431, 432, 433, and 434. FIG. 6 shows an embodiment where the negative film 510 is placed in the negative film scanning area 450 of the tray 110, and a positive film 610 is placed on the positive film holder 431.

As shown in FIG. 5, when the negative film 510 is sandwiched between the carrier 400 and the cover 480, the image frames of the negative film 510 are exposed within the negative film scanning area 450. In many situations, the user may only want to utilize the scanning apparatus 100 to scan some image frames of the negative film 510 rather than all of the image frames. In order to meet such a demand, the light-masking components 471 through 476 arranged beside the negative film scanning area 450 are designed in the form of switches in this embodiment, so that the user can select a target image frame to be scanned by moving the corresponding light-masking component. In one embodiment, for example, when an opening corresponding to an image frame is masked by a corresponding light-masking component, it means that the image frame is a target image frame selected by the user. In the case of FIG. 5, the opening 463 corresponding to an image frame 512 is masked by the light-masking component 473, it means that the image frame 512 is a target image frame selected by the user. Therefore, when the optical module of the scanning apparatus 100 pre-scans the tray 110, it can be detected that the openings 461, 462, and 464 through 466 beside the negative film scanning area 450 have light passing through them, but the opening 463 does not have light passing through it. According to such a detecting result, the scanning apparatus 100 is able to identify that only the image frame 512 of the negative film 510 needs to be scanned. This method not only saves the user from the inconvenience of manipulating a control panel or setting an application program, but also significantly reduces the total scanning time. If the scanning apparatus 100 is applied in a printing apparatus, the disclosed method can also reduce required consumables of the printing apparatus. In practice, the method to select a target image frame is not limited to that illustrated in the foregoing embodiments, and the light-masking components are not limited to be implemented in the form of switches.

In FIG. 5, there is no positive film being placed on the four positive film holders 431, 432, 433, and 434, and the openings 441, 442, 443, and 444 corresponding to these positive film holders are not masked. Thus, when the optical module of the scanning apparatus 100 pre-scans the tray 110, it can be detected that the above four openings 441, 442, 443, and 444 have light passing through them, and the scanning apparatus 100 can accordingly determine that the tray 110 has no positive film needing to be scanned.

In the embodiment shown in FIG. 6, the negative film 510 is sandwiched between the carrier 400 of the tray 110 and the cover 480, but none of the openings 461 through 466 beside the negative film scanning area 450 is masked by the light-masking component. Therefore, when the optical module of the scanning apparatus 100 pre-scans the tray 110, it can be detected that the openings 461 through 466 beside the negative film scanning area 450 have light passing through them, and the scanning apparatus 100 can accordingly determine that no negative film on the tray 110 needs to be scanned. On the other hand, since the positive film 610 is placed on the positive film holder 431 of the tray 110 shown in FIG. 6, the opening 441 corresponding to the positive film holder 431 would be masked by the plastic frame of the positive film 610. As a result, when the optical module of the scanning apparatus 100 pre-scans the tray 110, it can be detected that the openings 442, 443, and 444 corresponding to the positive film holders 432, 433, and 434 have light passing through them, but the opening 441 corresponding to the positive film holder 431 does not have light passing through it. According to this detecting result, the scanning apparatus 100 is able to identify that only the positive film holder 431 of the tray 110 has a positive film needing to be scanned and the other positive film holders do not have film needing to be scanned. In practice, the position of the opening corresponding to each positive film holder is not limited to that illustrated in the foregoing embodiments. For example, in an alternative embodiment, the opening corresponding to each positive film holder is arranged outside the positive film holder, and a moveable light-masking component (similar to each of the light-masking components 471 through 476) is arranged near the opening. In this case, the user can select one or more positive films needing to be scanned by adjusting the light-masking components.

Please note that the implementation of the light-masking components may vary with the type of the machine detectable mechanism. For example, if the openings 461 through 466 beside the negative film scanning area 450 are realized by electrically detectable structures, such as RFID tags, the corresponding light-masking components 471 through 476 should be replaced by electrical shielding components to block the electrical induction between the electrically detectable structures and the detecting module 120. Thereto, if the openings 461 through 466 beside the negative film scanning area 450 are realized by magnetically detectable structures, such as magnetic barcodes, the corresponding light-masking components 471 through 476 should be replaced by magnetic shielding components to block the magnetic induction between the magnetically detectable structures and the detecting module 120.

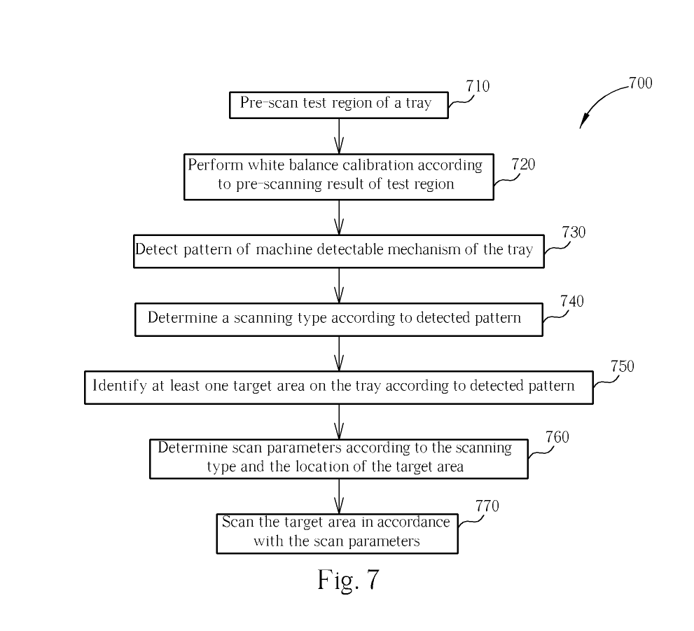

Hereinafter, an exemplary scanning method of the present invention will be described with reference to flowchart 700 illustrated in FIG. 7.

In step 710, the scanning module 140 of the scanning apparatus 100 pre-scans a test region of the currently used tray 110, such as the test region 210 or 410 shown in previous drawings.

In step 720, the control circuit 130 of the scanning apparatus 100 then performs a white balance calibration to compensate unbalanced luminance of the lamps of the scanning module 140 according to the pre-scanning result of the test region obtained by the scanning module 140.

In step 730, the detecting module 120 of the scanning apparatus 100 detects the pattern of the machine detectable mechanism of the tray 110. As in the foregoing illustrations, the detecting module 120 may detect the number and locations of the openings on the tray 110.

In step 740, the control circuit 130 identifies the type of the tray 110 (or the type of objects to be scanned on the tray 110) according to the pattern of the machine detectable mechanism detected by the detecting module 120, thereby determining a scanning type. For example, the control circuit 130 can determine that the object to be scanned on the tray 110 is either a reflection copy or a transparency according to the number and locations of the openings arranged beside the test region of the tray 110.

In step 750, the control circuit 130 identifies at least one target area on the tray 110 according to the detecting result obtained by the detecting module 120 in step 730. For example, suppose that the control circuit 130 determines that the tray 110 is the type shown in FIG. 4 in step 740, and the detecting module 120 found that the openings 441, 442, 443, 444, 461, 462, and 464 through 466 have light passing through them but the opening 463 does not have light passing through it (as the case shown in FIG. 5) in step 730, then the control circuit 130 identifies the area corresponding to the image frame 512 within the negative film scanning area 450 as a target area in step 750. Thereto, if the tray 110 is the type shown in FIG. 4, and the detecting module 120 found that the openings 442, 443, 444, and 461 through 466 have light passing through them but the opening 441 does not have light passing through it (as the case shown in FIG. 6) in step 730, then the control circuit 130 identifies an area within the positive film holder 431 that corresponds to an image frame 612 of the positive film 610 as a target area in step 750.

In step 760, the control circuit 130 then sets scan parameters of the scanning module 140 according to the scanning type determined in step 740 and the target area identified in step 750. For example, the control circuit 130 may control the scanning module 140 to utilize a corresponding light source according to the scanning type, and set an active image capture range for the scanning module 140 according to the location or coordinates of the target area.

Afterward, the scanning module 140 performs step 770 to scan the target area in accordance with the scan parameters set by the control circuit 130. In a preferred embodiment, the scanning module 140 only scans the target area.

Note that the executing order of the steps in the flowchart 700 is merely an example rather than a restriction of the practical implementations. For example, step 720 may be performed after step 750 or 760. In addition, steps 710 and 730 may be performed concurrently.

As in the foregoing illustrations, the disclosed scanning apparatus 100 and scanning methods are capable of automatically identifying the type of objects to be scanned and locating the objects according to the pattern of the machine detectable mechanism arranged on the tray 110. In this way, the convenience of usage and scanning performance can be significantly improved. Additionally, since the user has no need to set the scan parameters of the scanning apparatus 100 by manipulating the control panel or by adjusting parameters of the application program, the controlling approach of the scanning apparatus 100 can be simplified to be a “one touch” mechanism. That is, the scanning apparatus 100 only requires a start button allowing the user to command the scanning apparatus 100 to start the scanning operations. Once the user presses the start button, the scanning apparatus 100 can automatically identify the type of objects on the tray 110, locate the objects to be scanned, and then scan them. In practice, the controlling approach of the scanning apparatus 100 may be implemented with voice control means, which allows the user to command the scanning apparatus 100 to start the scanning operations by using voice. As a result, the scanning apparatus 100 can be implemented without any control button or control panel, thereby reducing the hardware cost and increasing the flexibility of designing the appearance of the scanning apparatus 100.

It can be appreciated by those skilled in the art that the disclosed scanning apparatus 100 can cooperate with an image printing apparatus to accomplish the functionality of image printing. Therefore, the architecture of the disclosed scanning apparatus 100 and related scanning methods can be applied in various electronic devices with image scanning functionality, such as sheet-fed scanners, flat-bed scanners, copy machines, multi-function products, etc.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for scanning objects on a tray, the tray being provided with a machine detectable mechanism, the method comprising:
detecting a pattern of the machine detectable mechanism;
identifying at least one target area on the tray according to the detecting result of the machine detectable mechanism;
setting scan parameters according to a location of the at least one target area; and
scanning the at least one target area according to the scan parameters.

2. The method of claim 1, wherein the machine detectable mechanism comprises at least one optically detectable structure.

3. The method of claim 2, wherein the optically detectable structure is a transparent structure, a reflecting part, or a light emitting component.

4. The method of claim 2, wherein the machine detectable mechanism further comprises at least one light-masking component for masking the optically detectable structure.

5. The method of claim 1, wherein the machine detectable mechanism comprises at least one electrically detectable structure.

6. The method of claim 5, wherein the electrically detectable structure is an RFID tag.

7. The method of claim 5, wherein the machine detectable mechanism further comprises at least one electrical shielding component for masking the electrically detectable structure.

8. The method of claim 1, wherein the machine detectable mechanism comprises at least one magnetically detectable structure.

9. The method of claim 8, wherein the magnetically detectable structure is a magnetic barcode.

10. The method of claim 8, wherein the machine detectable mechanism further comprises at least one magnetic shielding component for masking the magnetically detectable structure.

11. The method of claim 1, further comprising:
determining a scanning type according to the detecting result of the machine detectable mechanism.

12. The method of claim 11, wherein the step of setting scan parameters determines the scan parameters according to the scanning type and the location of the at least one target area.

13. The method of claim 1, wherein the tray is further provided with a test region, and the method further comprises:
performing a white balance calibration according to the pre-scanning result of the test region.

14. A scanning apparatus comprising:
a tray for supporting objects to be scanned, wherein the tray is provided with a machine detectable mechanism;
a detecting module for detecting a pattern of the machine detectable mechanism;
a control circuit coupled to the detecting module for identifying at least one target area on the tray according to a detecting result of the detecting module and for setting scan parameters according to a location of the at least one target area; and
a scanning module coupled to the control circuit for scanning the at least one target area according to the scan parameters.

15. The scanning apparatus of claim 14, wherein the machine detectable mechanism comprises at least one optically detectable structure.

16. The scanning apparatus of claim 15, wherein the optically detectable structure is a transparent structure, a reflecting part, or a light emitting component.

17. The scanning apparatus of claim 15, wherein the machine detectable mechanism further comprises at least one light-masking component for masking the optically detectable structure.

18. The scanning apparatus of claim 14, wherein the machine detectable mechanism comprises at least one electrically detectable structure.

19. The scanning apparatus of claim 18, wherein the electrically detectable structure is an RFID tag.

20. The scanning apparatus of claim 18, wherein the machine detectable mechanism further comprises at least one electrical shielding component for masking the electrically detectable structure.

21. The scanning apparatus of claim 14, wherein the machine detectable mechanism comprises at least one magnetically detectable structure.

22. The scanning apparatus of claim 21, wherein the magnetically detectable structure is a magnetic barcode.

23. The scanning apparatus of claim 21, wherein the machine detectable mechanism further comprises at least one magnetic shielding component for masking the magnetically detectable structure.

24. The scanning apparatus of claim 14, wherein the control circuit further determines a scanning type according to the detecting result of the machine detectable mechanism, and determines the scan parameters according to the scanning type and the location of the at least one target area.

25. The scanning apparatus of claim 14, wherein the tray further comprises a test region, the scanning module further pre-scans the test region, and the control circuit performs a white balance calibration according to the pre-scanning result of the test region.

26. A scanning apparatus comprising:
a tray for supporting objects to be scanned, wherein the tray is provided with an optically detectable structure;
an optical module for detecting a pattern of the optically detectable structure; and
a control circuit coupled to the optical module for setting scanning parameters according to the detecting result of the optical module and for controlling the optical module to scan the objects on the tray.
